(19) United States
(12) Patent Application Publication
(10) Pub. No.: US 2017/0100848 A1
(43) Pub. Date: Apr. 13, 2017

(54) CUTTING BOARD WITH REMOVABLE PIVOT KNIFE

(71) Applicant: André BERTHELETTE, St-Jerome (CA)

(72) Inventor: André BERTHELETTE, St-Jerome (CA)

(21) Appl. No.: 15/290,920

(22) Filed: Oct. 11, 2016

Related U.S. Application Data
(60) Provisional application No. 62/239,727, filed on Oct. 9, 2015.

(51) Int. Cl. B26D 1/30; B26B 3/00; A47J 47/00; B26D 7/01; B26D 7/20; B26B 29/06; B26D 1/00

(52) U.S. Cl. CPC B26D 1/30; B26B 29/063; B26B 3/00; B26D 1/0006; B26D 7/01; B26D 7/20; A47J 47/005; B26D 2001/0053

(57) ABSTRACT

A cutting board with removable pivot knife, comprising a knife having a handle at a first extremity and a notch at a second extremity, the notch being inclined towards the top of the knife and the handle and a base having a support surface for receiving a food item thereon, a knife anchoring element having a slot and a pivot positioned therein perpendicularly to the slot. To secure the knife to the base, the knife is first inclined so that the notch faces the knife anchoring element and is then displaced in a translational motion towards the knife anchoring element until the knife enters slot and the notch engages the pivot, the knife is then pivoted towards the support surface, resulting in the knife being secured to the base.

### CROSS-REFERENCE TO RELATED APPLICATIONS

This application claims the benefits of U.S. provisional patent application No. 62/239,727 filed on Oct. 9, 2015, which is herein incorporated by reference.

### TECHNICAL FIELD

The present disclosure relates to a cutting board with removable pivot knife.

### BACKGROUND

Some food items require precision, stability and/or much force to cut. For example, lobsters are typically cracked with a hand tool, which makes the user prone to cuts and requires a certain force to be applied. Furthermore, the use of such tools often results in the scattering of pieces of lobster.

Accordingly, there is a need for a cutting implement that is safe, precise, stable and reduces the force that needs to be applied.

### SUMMARY

In accordance with an illustrative embodiment of the present disclosure, there is provided a cutting board with removable pivot knife, comprising:
a knife having:
   a handle at a first extremity and a notch at a second extremity, the notch being inclined towards the top of the knife and the handle;
a base having:
   a support surface for receiving a food item thereon;
   a knife anchoring element having a slot and a pivot positioned therein perpendicularly to the slot;

wherein to secure the knife to the base, the knife is first inclined so that the notch faces the knife anchoring element and is then displaced in a translational motion towards the knife anchoring element until the knife enters slot and the notch engages the pivot, the knife is then pivoted towards the support surface, resulting the knife being secured to the base.

In accordance with another illustrative embodiment of the present disclosure, there is provided a cutting board with removable pivot knife as described above, wherein the blade further includes a toothed portion having teeth inclined towards the tip of the blade for gripping and holding the food item.

In accordance with a further illustrative embodiment of the present disclosure, there is provided a cutting board with removable pivot knife as described above, wherein the support surface further includes a longitudinal groove in its center so as to receive the knife when pivoted towards the support surface, allowing the knife to completely cut through the food item, sidewalls and/or at least one protuberance for holding in place the food item positioned onto the support surface.

### BRIEF DESCRIPTION OF THE FIGURES

Embodiments of the disclosure will be described by way of examples only with reference to the accompanying drawings, in which:

FIG. 1 is a side perspective view of a cutting board with removable pivot knife in accordance with an illustrative embodiment of the present disclosure;

FIG. 2A is a front perspective view of the cutting board with removable pivot knife showing the securing of the knife;

FIG. 2B is close-up view of FIG. 2A;

FIG. 3 is side cross-section view of the cutting board with removable pivot knife showing the knife secured to the cutting board; and

FIG. 4 is a side perspective view of a cutting board with removable pivot knife in accordance with an alternative illustrative embodiment of the present disclosure.

Similar references used in different Figures denote similar components.

### DETAILED DESCRIPTION

Generally stated, the non-limitative illustrative embodiments of the present disclosure provide a cutting board with removable pivot knife, which can be used, for example, to crack lobsters. This facilitates the cleaning of the cutting board with removable pivot knife as well as its storage.

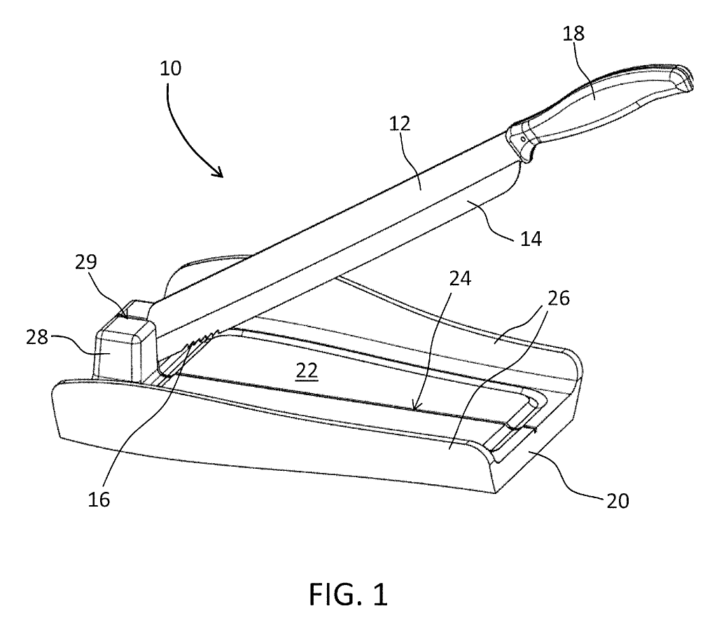

Referring to FIG. 1, the cutting board with removable pivot knife 10 in accordance with an illustrative embodiment of the present disclosure generally includes a knife 12 and a base 20.

The knife 12 includes a blade 14 having, optionally, a toothed portion 16, advantageously having teeth inclined towards the tip of the blade 14 in order to grip and hold a food item such as, for example, a lobster, positioned underneath, and a handle 18 for handling the knife 12.

The base 20 includes a support surface 22 with sidewalls 26 for receiving a food item therein, the support surface 22 having a longitudinal groove 24 in its center in line with the knife 12 so as to receive the blade 14 when the knife 12 is pivoted towards the surface 22, allowing the blade 14 to completely cut through a food item positioned underneath. The base 20 further includes a knife-anchoring element 28 having a slot 29, aligned with longitudinal groove 24, for receiving the knife 12.

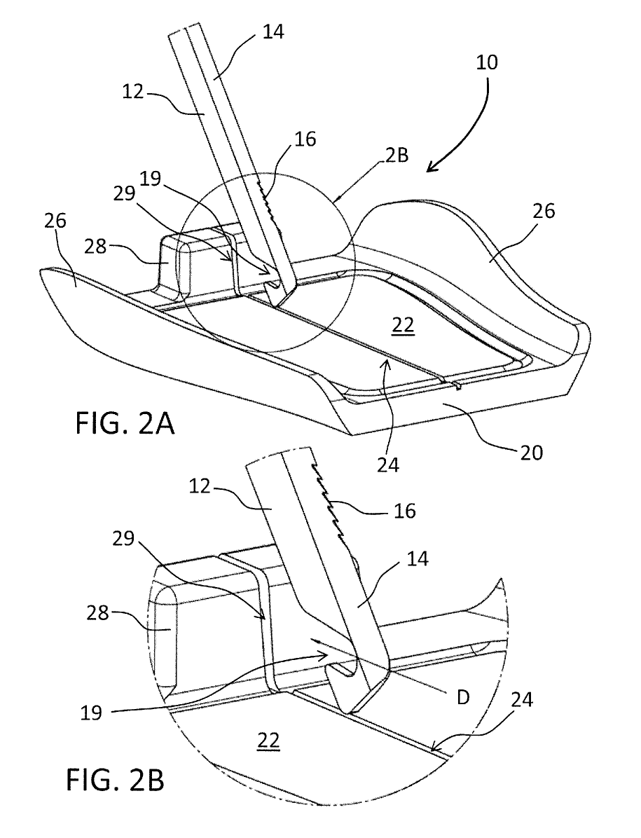

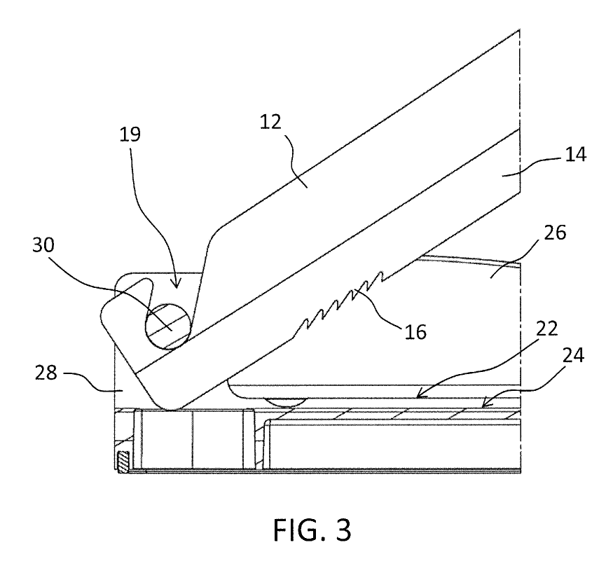

Referring now to FIGS. 2A, 2B and 3, the knife 12 is provided with a notch 19 at its extremity opposite the handle 18, the notch 19 being inclined towards the top and rear of the knife so as to removably secure the knife 12 to the base 20.

To secure the knife 12 to the base 20, the knife 12 is first inclined so that its notch 19 faces the knife anchoring element 28 (FIG. 2A) and is then displaced in a translational motion in direction D, along longitudinal groove 24 (FIG. 28), until the knife 12 enters slot 29 and its notch 19 engages a pivot 30 positioned perpendicularly to the slot 29 within the knife anchoring element 28. The knife 12 is then pivoted towards the support surface 22 (FIG. 3), which results in it being secured to the knife-anchoring element 28.

The pivot 30 combined with surface 22 and the inclination of notch 19 make it so that the knife 12 can only be removed by inclining it at a similar angle as when it was first engaged to the base 20 and then displacing it in a translational motion opposite direction D (FIG. 2B).

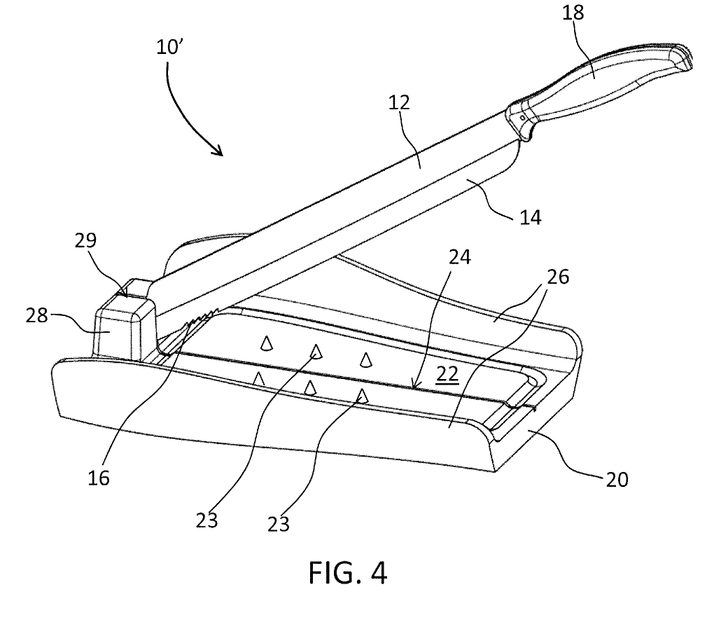

Referring now to FIG. 4, the cutting board with removable pivot knife 10′ in accordance with an alternative illustrative embodiment of the present disclosure generally includes all of the features of the previously described cutting board with removable pivot knife 10 with the addition of a one or more protuberance 23 for holding in place a food item positioned onto the support surface 22. It is to be understood that the number, shape and disposition of the one or more protuberance 23 may vary.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope and spirit of the present disclosure and as hereinafter claimed.

What is claimed is:

1. A cutting board with removable pivot knife, comprising:
a knife having:
a handle at a first extremity and a notch at a second extremity, the notch being inclined towards the top of the knife and the handle;
a base having:
a support surface for receiving a food item thereon;
a knife anchoring element having a slot and a pivot positioned therein perpendicularly to the slot;
wherein to secure the knife to the base, the knife is first inclined so that the notch faces the knife anchoring element and is then displaced in a translational motion towards the knife anchoring element until the knife enters slot and the notch engages the pivot, the knife is then pivoted towards the support surface, resulting in the knife being secured to the base.

2. The cutting board with removable pivot knife of claim 1, wherein the blade further includes a toothed portion having teeth inclined towards the tip of the blade for gripping and holding the food item.

3. The cutting board with removable pivot knife of claim 1, wherein the support surface further includes a longitudinal groove in its center so as to receive the knife when pivoted towards the support surface, allowing the knife to completely cut through the food item.

4. The cutting board with removable pivot knife of claim 1, wherein the support surface further includes sidewalls.

5. The cutting board with removable pivot knife of claim 1, wherein the support surface further includes at least one protuberance for holding in place the food item positioned onto the support surface.
